(19) United States
(12) Patent Application Publication
(10) Pub. No.: US 2020/0227794 A1
(43) Pub. Date: Jul. 16, 2020

(54) ADHESIVELY JOINED COOLING PLATE

(71) Applicant: GM GLOBAL TECHNOLOGY OPERATIONS LLC, Detroit, MI (US)

(72) Inventors: Jason Mazza, Oxford, MI (US); Robert J. Schoenherr, Oxford, MI (US); Todd H. Fast, Huntington Woods, MI (US); Roger M. Brisbane, Washington, MI (US)

(21) Appl. No.: 16/244,795

(22) Filed: Jan. 10, 2019

(51) Int. Cl. H01M 10/613; H01M 10/625; F28F 21/06; F28F 3/12; F28F 21/08; H01M 10/6555; H01M 10/6557

(52) U.S. Cl. CPC H01M 10/613; H01M 10/625; F28F 21/065; F28F 3/12; F28F 2265/16; H01M 10/6555; H01M 10/6557; F28F 2275/025; F28F 21/081

(57) ABSTRACT

In an embodiment, a cooling plate comprises a first substrate and a second substrate; wherein the first substrate and the second substrate are adhesively bonded via an adhesive layer; wherein a conduit is formed between the first substrate and the second substrate having an inlet and an outlet that forms a flow field for a coolant to flow through; wherein the adhesion layer forms a tight fluid seal to prevent leakage of the coolant from the conduit to a bonded region proximal to the conduit area between the first substrate and the second substrate.

### INTRODUCTION

Electrical systems within vehicles, such as hybrid, electric, and fuel cell vehicles, have advanced in complexity and power usage, relying in part on large batteries to store energy. Energy flowing into the battery or being discharged from the battery to power the vehicle and its accessories causes heating in the battery cells, where the higher the current flow, the greater the heating effect. Unfortunately, the increased heat in the battery assembly can disadvantageously impact its performance. Cooling systems are therefore provided in battery packs to maintain a particular operating temperature or temperature range of the battery. These cooling systems, however, can present high manufacturing costs and can add a significant amount of weight to the battery.

Accordingly, it is desirable to provide an improved cooling system.

### SUMMARY

In one exemplary embodiment a cooling plate comprises a first substrate and a second substrate. The first substrate and the second substrate are adhesively bonded via an adhesive layer. A conduit is formed between the first substrate and the second substrate having an inlet and an outlet that forms a flow field for a coolant to flow through. The adhesion layer forms a tight fluid seal to prevent leakage of the coolant from the conduit to a bonded region proximal to the conduit area between the first substrate and the second substrate.

In addition to one or more of the features described herein, at least one of the first substrate and the second substrate can comprise a metal.

In addition to one or more of the features described herein at least one of the first substrate and the second substrate comprises a polymer. The polymer can comprise at least one of a silicone, an elastomer, a polyolefin, a polyvinyl chloride, a polystyrene, a polyamide, a polyimide, a polyurethane, or a polyester.

In addition to one or more of the features described herein, the adhesive layer can comprise at least one of a pressure sensitive adhesive, a heat activated adhesive, or a UV activated adhesive.

In addition to one or more of the features described herein, the adhesive layer can comprise at least one of a silicone polymer, an epoxy, an alkyd, ethylene vinyl acetate, an acrylic polymer, a polyolefin, or a polyurethane.

In addition to one or more of the features described herein, the adhesive layer can comprise an adhesive tape.

In addition to one or more of the features described herein, the conduit can have at least one of a channel width of 1 to 10 millimeters or a channel height of 1 to 6 millimeters.

In addition to one or more of the features described herein, the conduit can have at least one inlet and at least one outlet connected by a serpentine path comprising one or more cooling segments, each having a different channel width.

In addition to one or more of the features described herein, one of the first substrate and the second substrate can comprise a raised portion and the other of the first substrate and second substrate can be flat.

In addition to one or more of the features described herein, the first substrate can comprise a first raised portion and the second substrate can comprise a second raised portion.

In addition to one or more of the features described herein, the first raised portion and the second raised portion can be co-localized to form the conduit in at least an area of the cooling plate. The conduit in the co-localized area can be free of the adhesive layer.

In addition to one or more of the features described herein, the first raised portion and the second raised portion can be not co-localized to form separate conduits in at least an area of the cooling plate.

In addition to one or more of the features described herein, the conduit can be free of the adhesive layer.

In addition to one or more of the features described herein, the area of the bonded region can be greater than or equal to a product of a maximum operating fluid pressure of the cooling plate and a total surface area of the conduit divided by an adhesive strength of the adhesive.

In another exemplary embodiment, a battery can comprise the cooling plate.

In yet another exemplary embodiment, a method of forming the cooling plate can comprise applying an adhesive to at least one of the first substrate and the second substrate and stacking the first substrate and the second substrate to form the adhesive layer located in between the first substrate and the second substrate.

In addition to one or more of the features described herein the adhesive can be applied by at least one of roll coating, spray coating, screen printing, dip coating, painting, or applying an adhesive tape.

In addition to one or more of the features described herein, the adhesive can be applied to 50 to 100 area percent, or 70 to 100 area percent, or 85 to 99 area percent of the respective substrate.

In addition to one or more of the features described herein, the method can comprise masking at least a conduit area prior to applying the adhesive.

In addition to one or more of the features described herein, at least one of the first substrate and the second substrate can comprise a roughed area or a plurality of protrusion in a bonding region to increase the adhesive strength.

The above features and advantages, and other features and advantages of the disclosure are readily apparent from the following detailed description when taken in connection with the accompanying drawings and claims.

### BRIEF DESCRIPTION OF THE DRAWINGS

Other features, advantages, and details appear, by way of example only, in the following detailed description, the detailed description referring to the drawings in which:

FIG. 1 is a disassembled isometric view of an embodiment of a cooling plate;

FIG. 2 is a top down view of an embodiment of the cooling plate;

FIG. 3 is a cross-section taken along line A of FIG. 2 including raised portions in the first substrate forming conduits comprising the adhesive layer;

FIG. 4 is a cross-section taken along line A of FIG. 2 including raised portions in the first substrate forming conduits free of the adhesive layer;

FIG. 5 is a cross-section taken along line A of FIG. 2 including raised portions in the first substrate and second substrate forming co-localized conduit(s);

FIG. 6 is a cross-section taken along line A of FIG. 2 including raised portions in the first substrate and second substrate forming non-localized conduits; and

FIG. 7 is a cross-section taken in a conduit that includes a transfer location.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Batteries often use cooling plates to help maintain the temperature of the battery within a desired range, thereby improving battery performance, minimizing the risk of failure, and reducing corrosive build-up. Cooling plates are generally formed from two metal substrates that are brazed or welded together to form a conduit for coolant flow. The bond strength between the respective metal plates that arises due to the brazing or welding is extremely strong and is known to be capable of withstanding the normal pressure that the coolant exerts on the cooling plate during operation. It was discovered that an adhesive layer could be used to form an adhesive bond between the two metal substrates instead of the conventional bond formed from brazing or welding and that the adhesive layer could provide a fluid tight seal to prevent leakage of coolant between the first substrate and the second substrate during operation. This result was surprising as it was previously thought that such an adhesive layer would not be capable of withstanding the operating pressure without coolant leakage.

In accordance with an exemplary embodiment, the cooling plate comprises a first substrate adhesively bonded via an adhesive layer to a second substrate. At least one of the first substrate and the second substrate includes a raised portion that forms a conduit in the cooling plate for coolant flow. As used herein, the term “raised” is with respect to the conduit height perpendicular to the adhesion layer. The conduit defines a flow field for the coolant having one or more inlets and one or more outlets. The specific path of the conduit is not particularly limited. The adhesive layer provides a fluid tight seal to prevent leakage of coolant from the conduit to a bonded region proximal to the conduit area between the first substrate and the second substrate.

Various benefits and advantages are afforded by the present cooling plate. For example, a reduced cost is associated with using the adhesive layer instead of brazing or welding. Furthermore, one or more of the metal substrates of the cooling plate can be replaced with polymeric substrates, which can further increase the cost reduction, result in a weight reduction of the battery, and improve the voltage isolation as compared to other cooling plates.

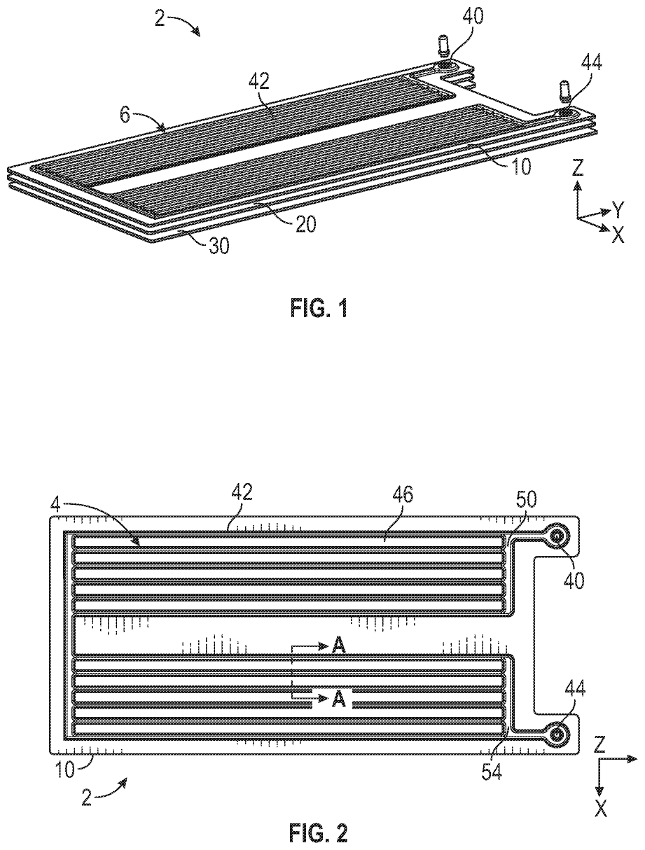

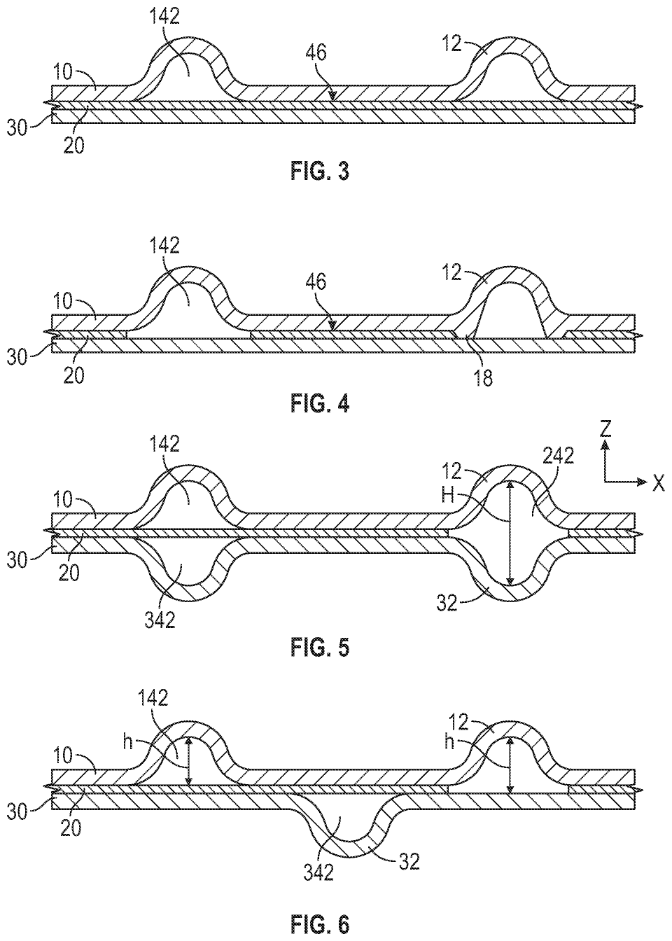

Referring to FIG. 1 and FIG. 2, these figures provide a disassembled isometric view and a top down view, respectively, of an embodiment of the cooling plate(s) 2. A cooling plate 2 includes a first substrate 10, a second substrate 30, and an adhesive layer 20 located therebetween. Raised portions 12, in FIG. 3-6, in one or both of the first substrate 10 and the second substrate 30 form conduits 42 that define a flow field 4 having an inlet 40 and an outlet 44 for coolant flow. A coolant can therefore flow from the inlet 40 to the outlet 44 through the conduits 42. A pump, not shown, can circulate the coolant through the cooling plate 2. The conduit 42 can include one or more branch points 50 to form multiple conduits 42 between the inlet 40 and the outlet 44. Each of the conduits 42 can further include various intermediate branch points 50 that split into further conduits or can include various intermediate coalescing points 54 where multiple conduits coalesce into a fewer number of conduits. A bonded region 46 is formed between a substrate that is in direct physical contact with the adhesion layer.

It is noted that the specific configuration of the flow field 4 defined by the conduit 42 and the number and location of the inlet(s) 40 and the outlet(s) 44 is not limited to the illustrated embodiment of FIG. 1 and FIG. 2. In general, the flow field 4 can be defined by one or more conduits of various lengths, dimensions, and branching/coalescing points between the inlet(s) 40 and the outlet(s) 44. In this way, heat exchange of the cooling plate 2 can be symmetric, asymmetric, optimized for a particular region of the cooling plate 2, or configured to be uniform across the cooling plate 2. Typically, the conduit 42 follows a tortuous path between the inlet(s) and the outlet(s), such as a serpentine path, where the path(s) cover a portion of a surface area of the cooling plate 2.

A ratio of the area of the bonded region to the conduit area in the x,y plane needed to maintain the tight fluid seal can be defined by the adhesion strength of the adhesive layer to the substrate relative to the coolant pressure in the conduit 42. The area of the bonded region can be greater than or equal to a product of the maximum operating fluid pressure of the cooling plate 2 and the total surface area of the conduit 42 divided by the selected adhesive strength.

At least one of the first substrate 10 and the second substrate 30 includes a raised portion that forms a conduit 42 in the cooling plate 2 for coolant flow. For example, one of the first substrate 10 and the second substrate 30 can include a raised portion and the other of the first substrate 10 and the second substrate 30 can be flat, as illustrated in FIG. 3 and FIG. 4. This embodiment can be beneficial as only one of the first substrate 10 and the second substrate 30 would need to have the raised portion, potentially reducing the design complexity and the number of steps for forming of the cooling plate 2.

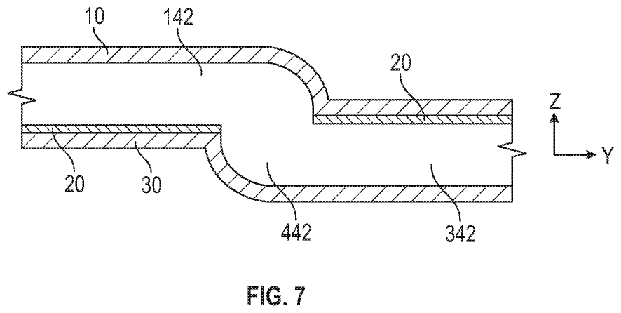

Conversely, both the first substrate 10 and the second substrate 30 can include raised portions as illustrated in FIG. 5-7. In different regions of the cooling plate 2, the raised portions of the first substrate 10 and the second substrate 30 can be co-localized forming the conduit 42 in the same location as illustrated in FIG. 5 or the raised portions can localize with a corresponding flat portion of the opposing substrate, as illustrated in FIG. 6. For example, the conduit 42 can traverse the cooling plate 2 on a first side, a second side, or both sides (for example, when the raised portions co-localize) at different locations in the flow field 4. The flow field 4 can be configured such that at least two separate conduits are formed for separate coolant flow, where a first conduit is defined by a raised portion of the first substrate 10 and a second conduit is defined by a raised portion of the second substrate 30. The flow field 4 can be configured such that the conduit is defined by a raised portion of the first substrate 10 in some locations and a second conduit is defined by a raised portion of the second substrate 30 in other locations with a transfer location 442 provided for the coolant to traverse the adhesive layer 20 from one side to the other, as illustrated in FIG. 7. The flow field 4 can be configured such that the conduit is defined by a raised portion of the first substrate 10 and the second substrate 30 co-localizing throughout the flow field 4. This embodiment can have the benefit of the respective raised portions having a reduced height, while forming an increased conduit height.

Referring to FIG. 3, FIG. 4, FIG. 5, and FIG. 6, these figures are cross-sectional illustrations along line A as illustrated in FIG. 2. FIG. 3 and FIG. 4 illustrate the first substrate 10 including raised portions 12 that form conduits 142. FIG. 3 illustrates that the adhesive layer 20 can be located in the conduit such that the coolant would flow over the adhesive layer 20 when in use. FIG. 4 illustrates that the adhesive layer 20 can be selectively localized to the bonded region such that the coolant will have a reduced contact with the adhesive of the adhesive layer 20. FIG. 4 further illustrates that the first substrate 10 can include a lip 18 that provides a barrier to prevent the coolant from being exposed to the coolant. It is noted that in addition to or instead of first substrate 10 including a lip, the second substrate 30 can likewise include a lip.

FIG. 5 illustrates that the first substrate 10 can include a raised portion 12 that forms a conduit 142 and that the second substrate 30 can include a raised portion 32 that forms a conduit 342 with the adhesive layer 20 located therebetween, forming a barrier for coolant flow. FIG. 5 also illustrates that the first substrate 10 can include a raised portion 12 and the second substrate 30 can include a raised portion 32 such that the respective raised portions form a conduit 242 such that the coolant can flow throughout the height, H, of conduit 242. FIG. 6 illustrates that the first substrate 10 can include raised portions 12 that form conduits 142 and that the second substrate 30 can include a raised portion 32 that form conduits 342, where the conduits 142 and 342 form separate conduits in different locations in the x,y plane. It is noted that the cooling plate 2 can have location in the x,y plane where the raised portions of the first substrate 10 and the second substrate 30 co-localize and portions where they are not co-localized. FIG. 7 illustrates a cross-section of the cooling plate 2 in the y-z plane. FIG. 7 illustrates that the flow field 4 can comprise a conduit 142 defined by a raised portion of the first substrate 10 and a second conduit 342 defined by a raised portion of the second substrate 30 with a transfer location 442 provided for the coolant to traverse the adhesive layer 20 from one side of the cooling plate 2 to the other.

The cooling plate 2 can be configured to be electrically insulating to prevent electrical current between the coolant and other objects. For example, the cooling plate 2 can be placed in thermal contact with a battery cell by positioning the cooling plate 2 against the battery cell or positioning the cooling plate 2 between two battery cells. In this manner, the electrically insulating cooling plate 2 can prevent electrical current between the coolant and the battery cell(s) as well as prevent electrical current between flanking battery cells. The cooling plate 2 can be electrically insulating through the use of electrically insulating materials for forming films. The films can be formed from an electrically insulating material, for example, at least one of polypropylene, polyimide, or polycarbonate.

The first substrate 10 and the second substrate 30 can each independently comprise at least one of a metal or a polymer. The metal can comprise at least one of aluminum, iron, copper, gold, silver, tungsten, nickel, stainless steel, or platinum. The metal can comprise at least one of aluminum, iron, nickel, or copper (for example, nickel-plated copper). The first substrate 10 and the second substrate 30 can each independently be metal plates, for example, comprising 90 to 100 weight percent, or 99 to 100 weight percent of the metal based on the total weight of the metal plate.

The first substrate 10 and the second substrate 30 can each independently comprise at least one of a silicone polymer, an elastomer, a polyolefin, a polyvinyl chloride, a polystyrene, a polyamide (for example, nylon), a polyimide, a polyurethane, or a polyester (for example, poly(ethylene terephthalate)). The first substrate 10 can comprise a metal such as aluminum and the second substrate 30 can comprise a polymer.

If one of the substrates 10, 30 comprises a polymer, it can further comprise at least one of a thermally conductive filler, a flame retardant, an anti-drip agent, or an impact modifier. The thermally conductive filler can comprise at least one of a metal (such aluminum) or a ceramic (such as alumina, (aluminum nitride), (boron nitride), silicon nitride, silicon carbide, or beryllium oxide). The flame retardant can comprise at least one of cyano melamine, or magnesium hydroxide.

The adhesive layer 20 comprises an adhesive, for example, comprising at least one of a silicone polymer, an epoxy, an alkyd, ethylene vinyl acetate, an acrylic polymer, a polyolefin, or a polyurethane. The adhesive layer 20 can comprise at least one of a pressure sensitive adhesive, a heat activated adhesive, or a UV activated adhesive. The adhesive layer 20 can comprise a double-sided adhesive tape comprising a base material with the adhesive located on opposing surfaces of the base material. The base material can comprise at least one of a polyolefin, a polyurethane, or an acrylic. The base material can be a foam or the base material can be free of a void space.

The adhesive layer 20 can comprise a silicone polymer, for example, a two-part room temperature vulcanizing (RTV) silicone rubber. The adhesive layer 20 can comprise an epoxy, for example, derived from a two-part epoxy resin and hardener. The adhesive layer 20 can comprise an alkyd. For example, the alkyd can be derived from an unsaturated polyester (such as a fumaric acid-ethylene glycol based polyester or a propoxylated bisphenol-A fumarate resin) or a styrene soluble alkyd polyester resins, styrene monomer, and a peroxide (for example, methylethylketone peroxide).

A bonding surface of one or both of the first substrate 10 and the second substrate 30 can be roughened or can comprise a plurality of protrusions to increase the adhesive strength between the adhesive layer 20 and the respective substrate.

The conduit 42 can have a maximum channel height as illustrated as h or H in the figures of 1 to 6 millimeters, or 1 to 3 millimeters. The channel height is the height of the conduit 42 measured perpendicular to the flow direction in the Z direction from the opposing surfaces of the conduit 42. FIG. 5 and FIG. 6 illustrate embodiments of the channel height. The conduit 42 can have an average channel width of 1 to 10 millimeters or 1 to 5 millimeters. The average channel width is the average width in the x,y plane perpendicular to the flow direction averaged along the height of the conduit 42.

The conduit 42 can have at least one inlet 40 and at least one outlet 44 connected by a serpentine path comprising one or more cooling segments. The one or more cooling segments can each independently have the same or a different channel width. For example, the segments can each independently have a channel width of 1 to 10 millimeters.

The raised portion 12 in the respective substrates can be formed by molding (for example, injection molding), cold extrusion, metal stamping, deep drawing, laminating, or casting (for example, shell casting or sand casting).

The cooling plate 2 can be formed by applying the adhesive to the first substrate 10 to form the adhesive layer 20 and stacking the second substrate 30 onto the adhesive layer 20. The adhesive can be applied to both the first substrate 10 and the second substrate 30 and the substrates can be stacked onto each other to form the cooling plate 2. The applying of the adhesive layer 20 can comprise at least one of roll coating, spray coating, screen printing, dip coating, painting, or applying an adhesive tape. The adhesive can be applied to 50 to 100 area percent, or 70 to 100 area percent, or 85 to 99 area percent of the respective substrate. The adhesive can be applied to the surface area of the respective substrate including the conduit area. In other words, the adhesive can be in contact with the coolant during use. When depositing an adhesive layer 20, a mask can be applied to the respective substrate in areas where the adhesive is not desired. For example, a mask can be applied to a substrate in the conduit area and the mask can be removed after the adhesive has been deposited. After stacking, the adhesive can be cured to form the adhesive layer 20. A barrier layer can be deposited onto the adhesive layer 20 in the conduit region to prevent the coolant from contacting the adhesive.

The adhesive can be sprayed onto one or both of the substrates 10, 30. For example, the adhesive can be sprayed onto a flat, first substrate 10 and a second substrate 30 having a raised portion can be stacked onto the adhesive layer 20. The adhesive can be sprayed onto a first substrate 10 having a raised portion 12 and a flat, second substrate 30 can be stacked onto the adhesive layer 20. The adhesive can be sprayed onto a first substrate 10 having a raised portion and a second substrate 30 having a raised portion can be stacked onto the adhesive layer 20.

The adhesive can be roll coated onto one or both of the substrates 10, 30. For example, the adhesive can be roll coated onto a flat, first substrate 10 and a second substrate 30 having a raised portion can be stacked onto the adhesive layer 20. The adhesive can be roll coated onto a first substrate 10 having a raised portion and a flat, second substrate 30 can be stacked onto the adhesive layer 20. The adhesive can be roll coated onto a first substrate 10 having a raised portion and a second substrate 30 having a raised portion can be stacked onto the adhesive layer 20. When the adhesive is roll coated onto a first substrate 10 having a raised portion, the raised portion can be free of the adhesive.

The adhesive can be screen printed onto one or both of the substrates 10, 30. For example, the adhesive can be screen printed onto a flat, first substrate 10 and a second substrate 30 having a raised portion can be stacked onto the adhesive layer 20. The adhesive can be screen printed onto a first substrate 10 having a raised portion and a flat, second substrate 30 can be stacked onto the adhesive layer 20. The adhesive can be screen printed onto a first substrate 10 having a raised portion and a second substrate 30 having a raised portion can be stacked onto the adhesive layer 20. When the adhesive is screen printed onto a first substrate 10 having a raised portion, the raised portion can be free of the adhesive. The adhesive can be screen printed such that it is not printed in the conduit area.

An adhesive tape can be applied to one or both of the substrates 10, 30. For example, the adhesive tape can be applied a flat, first substrate 10 and a second substrate 30 having a raised portion can be stacked onto the adhesive tape. The adhesive tape can be applied to a first substrate 10 having a raised portion and a flat, second substrate 30 can be stacked onto the adhesive layer 20. The adhesive tape can be applied to a first substrate 10 having a raised portion and a second substrate 30 having a raised portion can be stacked onto the adhesive layer 20. The adhesive tape can be a continuous tape that covers the entire surface (for example, greater than or equal to 95 area percent of the surface). The adhesive tape can comprise a cutout. The cutout can correspond to the raised portion such that the conduit 42 can be free of the adhesive tape.

A thickness of the adhesive layer 20 can be 0.2 to 1 millimeters.

The cooling plate 2 can be suitable for use in a heat exchanger or temperature regulation system for a battery cell or a battery cell assembly. The cooling plate 2 can include a flow field 4 for circulating a coolant to maintain an operating temperature or operating temperature range for one or more battery cells. The cooling plate 2 can be one of a plurality of cooling plates 2, for example, where each cooling plate 2 can be in thermal contact with a battery cell in a battery cell assembly. Where the battery assembly includes a stack of battery cells, cooling plates 2 can be interleaved with the battery cells.

The cooling plate 2 can withstand internal operating pressures up to 45 pounds per square inch (psi) (310 kilopascal (kPa), or 10 to 45 psi (69 to 310 kPa), or up to 25 psi (172 kPa), or 15 to 25 psi (103 to 172 kPa). The maximum internal operating pressure that the cooling plate 2 can withstand can be determined by sealing all but one of the inlets 40 and outlets 44 and increasing a coolant pressure in the conduit 42 at a rate of less than or equal to 10 kPa per minute and determining the coolant pressure at which a failure occurs. An example of a failure includes leaking of the coolant into the bonded region 46 proximal to a conduit area between the first substrate 10 and the second substrate 30.

When used as a coolant plate for a battery assembly, the battery assembly can be configured to supply high voltage direct current (DC) power to an inverter, which can include a three-phase circuit coupled to a motor to convert the DC power to alternating current (AC) power. In this regard, the inverter can include a switch network having an input coupled to the battery assembly and an output coupled to the motor. The switch network can include various series switches (for example, insulated gate bipolar transistors (IGBTs) within integrated circuits formed on semiconductor substrates) with antiparallel diodes (for example, antiparallel to each switch) corresponding to each of the phases of the motor. The battery assembly can include voltage adaption or transformation, such as DC/DC converters. One or more battery assemblies can be distributed within a vehicle where each battery assembly can be made up of a number of battery cells. The battery cells can be connected in series or parallel to collectively provide voltage to the inverter.

The battery assembly can be cooled by a coolant that flows through the flow field via a coolant loop including one or more cooling plates 2. The coolant can flow into one or more inlets 40 of the cooling plates 2 in thermal contact with the battery assembly to exchange heat with the battery cells. The coolant can then flow through one or more outlets 44 of the cooling plates 2. The fluid can then be recirculated through a coolant loop. Although the fluid in the conduit 42 is referred to herein as a “coolant,” it is noted that the coolant can heat or cool various components within the vehicle, including in the battery assembly.

The coolant can include any liquid that absorbs or transfers heat to cool or heat an associated component, such as water and/or ethylene glycol (i.e., “antifreeze”). The coolant can comprise at least one of air, nitrogen, water, ethylene glycol, ethanol, methanol, or ammonia. When in use, a liquid flow rate of the liquid coolant through the conduit 42 can be 1 to 15 liters per minute for and a gas flow rate of the gas coolant through the conduit 42 can be 200 to 300 meters cubed per hour.

When used in a vehicle, the battery pack or packs can be located in the front, middle, or rear of the vehicle. The battery pack or packs can be coupled to the bottom of the vehicle. Additionally or alternatively, the cooling plate 2 can be used in a cooling system for cooling in computer applications within and/or outside of the vehicle, where thermal conduction is required between interfaces. When used in a vehicle, the battery pack or packs can comprise a lithium-ion battery, for example, for use as a battery for a vehicle with hybrid drive or a fuel cell vehicle.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced item. The term “or” means “and/or” unless clearly indicated otherwise by context.

Reference throughout the specification to “an aspect”, “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments. The endpoints of all ranges directed to the same component or property are inclusive of the endpoints, are independently combinable, and include all intermediate points and ranges. For example, a range of “5 to 20 millimeters” is inclusive of the endpoints and all intermediate values of the ranges of such as 10 to 23 millimeters, etc.). The suffix “(s)” as used herein is intended to include both the singular and the plural of the term that it modifies, thereby including one or more of that term (e.g., the colorant(s) includes one or more colorants). The terms “first,” “second,” and the like, as used herein do not denote any order, quantity, or importance, but rather are used to distinguish one element from another. The term “at least one of” means that the list is inclusive of each element individually, as well as combinations of two or more elements of the list, and combinations of at least one element of the list with like elements not named. Unless defined otherwise, technical and scientific terms used herein have the same meaning as is commonly understood by one of skill in the art to which this invention belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A cooling plate, comprising:
a first substrate and a second substrate;
wherein the first substrate and the second substrate are adhesively bonded via an adhesive layer; wherein a conduit is formed between the first substrate and the second substrate having an inlet and an outlet that forms a flow field for a coolant to flow through;
wherein the adhesion layer forms a tight fluid seal to prevent leakage of the coolant from the conduit to a bonded region proximal to the conduit area between the first substrate and the second substrate.

2. The cooling plate of claim 1, wherein at least one of the first substrate and the second substrate comprises a metal.

3. The cooling plate of claim 1, wherein at least one of the first substrate and the second substrate comprises a polymer.

4. The cooling plate of claim 1, wherein the adhesive layer comprises at least one of a pressure sensitive adhesive, a heat activated adhesive, or a UV activated adhesive.

5. The cooling plate of claim 1, wherein the adhesive layer comprises at least one of a silicone polymer, an epoxy, an alkyd, ethylene vinyl acetate, an acrylic polymer, a polyolefin, or a polyurethane.

6. The cooling plate of claim 1, wherein the adhesive layer comprises an adhesive tape.

7. The cooling plate of claim 1, wherein the conduit has at least one of a channel width of 1 to 10 millimeters or a channel height of 1 to 6 millimeters.

8. The cooling plate of claim 1, wherein conduit has at least one inlet and at least one outlet connected by a serpentine path comprising one or more cooling segments, each having a different channel width.

9. The cooling plate of claim 1, wherein one of the first substrate and the second substrate comprises a raised portion and the other of the first substrate and second substrate is flat.

10. The cooling plate of claim 1, wherein the first substrate comprises a first raised portion and the second substrate comprises a second raised portion.

11. The cooling plate of claim 10, wherein the first raised portion and the second raised portion are co-localized to form the conduit in at least an area of the cooling plate.

12. The cooling plate of claim 10, wherein the first raised portion and the second raised portion are not co-localized to form separate conduits in at least an area of the cooling plate.

13. The cooling plate of claim 1, wherein the conduit is free of the adhesive layer.

14. The cooling plate of claim 1, wherein the area of the bonded region is greater than or equal to a product of a maximum operating fluid pressure of the cooling plate and a total surface area of the conduit divided by an adhesive strength of the adhesive.

15. A battery comprising the cooling plate of claim 1.

16. A method of forming a cooling plate, comprising:
applying an adhesive to at least one of a first substrate and a second substrate; and
stacking the first substrate and the second substrate to form an adhesive layer located in between the first substrate and the second substrate;
wherein a conduit is formed between the first substrate and the second substrate having an inlet and an outlet that forms a flow field for a coolant to flow through;
wherein the adhesion layer forms a tight fluid seal to prevent leakage of the coolant from the conduit to a bonded region proximal to the conduit between the first substrate and the second substrate.

17. The method of claim 16, wherein the adhesive is applied by at least one of roll coating, spray coating, screen printing, dip coating, painting, or applying an adhesive tape.

18. The method of claim 16, wherein the adhesive is applied to 50 to 100 area percent of the respective substrate.

19. The method of claim 16, further comprising masking at least a conduit area prior to applying the adhesive.

20. The method of claim 16, wherein at least one of the first substrate and the second substrate has a roughed area or a plurality of protrusion in a bonding region to increase the adhesive strength.
